(19) United States
(12) Patent Application Publication
(10) Pub. No.: US 2006/0201863 A1
(43) Pub. Date: Sep. 14, 2006

(54) Sterilization water tank

(76) Inventor: Young Chul Choi, Incheon (KR)

Correspondence Address: IPLA P.A., 3580 WILSHIRE BLVD., 17TH FLOOR, LOS ANGELES, CA, 90010, US

(21) Appl. No.: 10/565,374

(22) PCT Filed: Jul. 22, 2004
(86) PCT No.: PCT/KR04/01837

§ 371 Date: Jan. 20, 2006

(30) Foreign Application Priority Data
Jul. 23, 2003 (KR) 20-2003-0023729

(51) Int. Cl. C02F 1/50

(52) U.S. Cl. 210/209

(57) ABSTRACT

The invention relates to a sterilization water tank which may maximize the water sterilization effect and may improve the quality of water. According to an aspect of the invention, there is provided a sterilization water tank comprising a tank body where water is contained 20, and a silver foam 30 which is formed in a foam pattern having a plurality of holes and is contained in the tank body 20, and wherein the water in the tank body 20 may be sterilized by the silver foam 30.

### FIELD OF THE INVENTION

The invention relates to a sterilization water tank, more particularly, relates to a sterilization water tank which may maximize the water sterilization effect and may improve the quality of water.

### BACKGROUND OF THE INVENTION

Generally, a water tank is provided in an apparatus such as a water puffier or a water ionizer and so on. Accordingly, when a user opens a valve connected to the apparatus, the water in the water tank may be dispensed through the valve. And, in case of a common home or a shop and so on, a user contains water in a water tank and keeps the water tank in a refrigerator. And, whenever necessary, the user pours the water into a cup and the like from the water tank and drinks it.

By the way, in case that the water is contained in the water tank of the water purifier or the water ionizer and so on, there is a problem that the quality of water may be deteriorated as harmful bacteria may be bred in the water and the water may smell bad. Accordingly, a filter has been used for purifying the water, but the user should replace the filter periodically so that it may cause inconvenience to the user and the management cost may be increased.

### DETAILED DESCRIPTION OF THE INVENTION

The invention is created to solve the above described problems and so the object of the invention is to provide a sterilization water tank which may improve the quality of water by maximizing the water sterilization effect and which is convenient in use and may save the management cost.

According to an aspect of the invention, there is provided a sterilization water tank comprising a tank body 20 where water is contained; and a silver foam 30 which is formed in a foam pattern having a plurality of holes and is contained in the tank body 20;

and wherein the water in the tank body 20 may be sterilized by the silver foam 30.

According to another aspect of the invention, there is provided a sterilization water tank wherein the silver foam 30 is contained in a permeable housing 40.

### BRIEF DESCRIPTION OF THE DRAWINGS

FIG. 1 is a sectional view of an embodiment of the invention.

FIG. 2 is a sectional view of another embodiment of the invention.

### THE PREFERRED EMBODIMENT OF THE INVENTION

A preferred embodiment of the invention will be described in detail below by referring to the accompanying drawings.

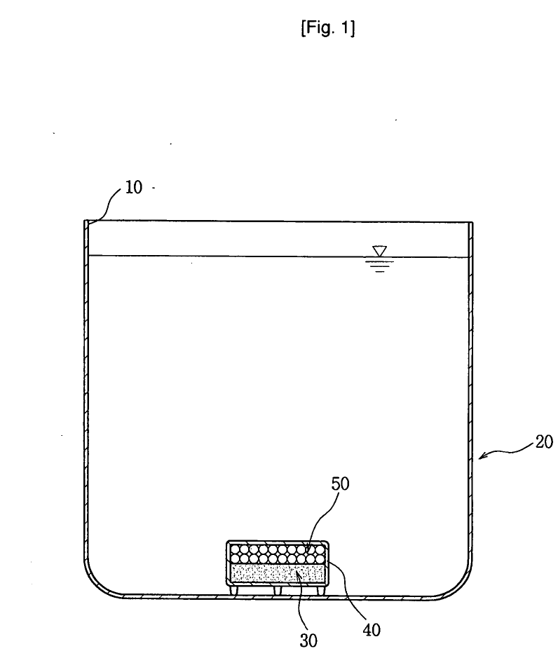

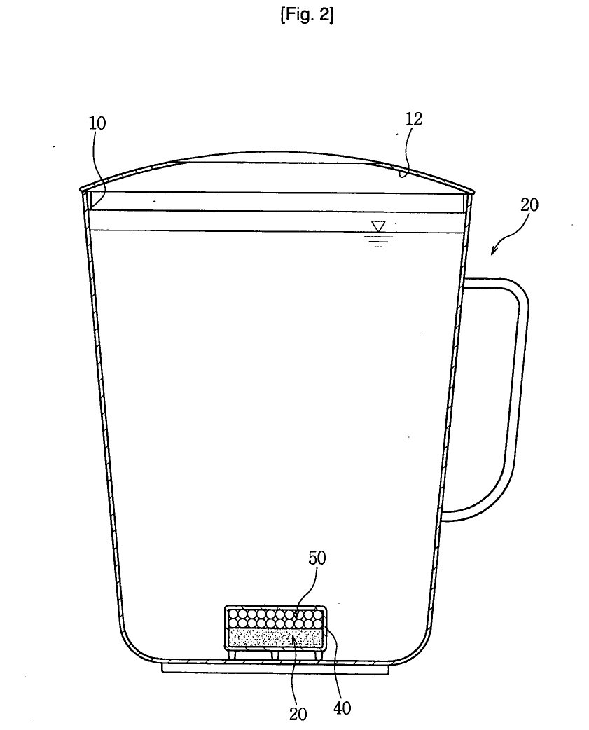

FIG. 1 is a sectional view of an embodiment of the invention, and FIG. 2 is a sectional view of another embodiment of the invention. Referring to the drawings, the invention comprises a tank body 20, and a silver foam 30.

The tank body 20 is to contain water therein, and an opening 10 is formed at the upper portion of the tank body 20. The tank body 20, as shown in FIG. 1, is a water tank which is mounted in a water dispenser such as a water purifier or a water ionizer and so on. And, the tank body 20, as shown in FIG. 2, is a water tank which is generally used in a common home or a shop and the like. An opening 10 is also formed at the upper portion of the tank body 20 of FIG. 2, and a cover 12 is detachably combined at the opening 10. Besides, the tank body 20 could be all kinds of the water tanks such as an aquarium, a fishing pot, an ordinary water container such as a plastic bottle and so on.

The silver foam 30 is formed in a foam block pattern and has a plurality of holes therein. The silver foam 30 is contained in the tank body 20 and sterilizes the water.

Particularly, the silver foam 30 is formed in a foam block pattern having a plurality of holes so that the water passes through the holes of the silver foam 30 and the contact area between silver and harmful bacteria or harmful alien material may be widened. Accordingly, the water sterilization effect may be maximized because the harmful bacteria or the alien material may be caught as much as possible. And, the silver foam 30 may be used almost eternally compared with a conventional water filter so that there is no need replacing the silver foam 30 until the life span of the apparatus using the silver foam 30 has been expired. Accordingly, the invention is so convenient in use and may save the management cost.

Preferably, the silver foam 30 is contained in a permeable housing 40 which has a plurality of water holes. In case that the silver foam 30 is contained in the permeable housing 40, the fife span of the silver foam 30 may be prolonged more so that the user may use the invention more conveniently and the management cost may be saved more. Further, the numbers or the size of the silver foam 30 is preferably adjusted according to the volume of the tank body 20, so to speak, the amount of the water to be contained in the tank body 20.

Meanwhile, when the silver is in an ionized state, it may kill colitis germs only with extremely small amount like as about several ten ppb. The term [symbol] ?ppb [symbol] ? is the initials of [symbol] ?parts per billion [symbol] ?, and it is a unit related to density and means one billionth.

Silver solution of 1 ppb means that silver of 1 g is resolved in the water contained in a cubic water tank one side of which is 10M. Accordingly, it is thought that even small amount of silver may do sufficient effect. And, the silver antibiotics may do antibiotic effect on a variety of bacteria.

Like the above, because silver has a metal which may do high antibiotic effect and is so safe, it may be used as main substance of antibiotics. Here, the main substance of antibiotics is inorganic antibiotics. The antibiotic substance of the inorganic antibiotics is a metal. There is Hg and the like among the metals hawing antibiotic effect. However, for the sake of safety, Ag, Cu and Zn have been used for the inorganic antibiotics. Particularly, because Ag may do high antibiotic effect and it is so safe in use, the silver may be the main substance of the inorganic antibiotics. Recently, silver antibiotics has become the main antibiotics among the various inorganic antibiotics.

The table below shows MIC (minimum inhibitory concentration) of silver ion and copper ion against bacteria and etc.

<MIC(ppm) of silver ion and copper ion against bacteria and etc.>

| | Silver ion | Copper ion |
|---|---|---|
| Bacteria | 0.78 | 400 |
| Colitis germs | 6.3 | 200 |
| Staphylococcus | 0.78 | 400 |
| Pseudomonas aeruginosa | 0.78 | 400 |
| Salmonella | 0.78 | 400 |
| Pneumonia bacillus | 0.78 | 200 |
| Rice-straw bacillus | 1.56 | 400 |

Like the above table, for example, while 400 pieces of bacteria are bred in copper ion, only about 1 piece of bacteria is bred in silver ion. Accordingly, the silver foam 30 may do the most excellent antibiotic effect compared with the other antibiotics. And, the state of the silver antibiotics is never changed in a normal temperature so that the antibiotic effect of silver may be kept until the life span of the apparatus applying the silver foam 30 has been expired.

Accordingly, the sterilization water tank has an advantage that a silver foam 30 is contained in the tank body 20 and harmful bacteria may be sterilized by the silver foam 30 so that the water does not smell bad and harmful bacteria is not mixed in the water and it may contribute to the heath of the users who drink the water. And, the sterilization water tank has an advantage that, in case of the water tank where a fish lives such as an aquarium and a fishing pot, the harmful bacteria in the aquarium or the fishing pot may be sterilized by the silver foam 30 so that it may provide the environment where the fish may be bred more healthily. And, different from the prior filter which should be frequently replaced, the life span of the silver foam 30 is semi-permanent and need not to be replaced frequently so that a user may use the invention so conveniently and the management cost may be save.

Further, because the silver foam 30 is formed with a foam pattern which has a plurality of holes and the water passes through the holes, the contact area between the silver and the harmful bacteria or a variety of harmful alien material may be widened and the harmful bacterial or the alien material may be captured as mush as possible so that the sterilization effect may be maximized.

And, as shown in the drawings, ceramic balls 50 may be provided at one side of the silver foam 30. The ceramic balls 50 has sterilization function and radiates far infrared rays so that the synergy effect may be expected as the sterilization effect may be increased more.

Here, the sterilization water tank of the invention may be applied to all kinds of the water tank which contain the water such as the water tank of a humidifier or of a refrigerator besides that of a water purifier, a water ionizer, an aquarium or a fishing pot.

### INDUSTRIAL APPLICABILITY

According to the above described invention, the sterilization water tank has an advantage that harmful bacteria in the tank body may be sterilized by a silver foam and the quality of water is not deteriorated so that it may contribute to the health of a user who dunks the water. And, the invention has an advantage that, in case of an aquarium or a fishing pot, the harmful bacteria in the aquarium or the fishing pot may also be sterilized by the silver foam so that the suitable environment may be provided where the fishes may be bred more healthily. And, the invention is so convenient in use because there is no need replacing the silver foam periodically and it may save the management cost and so on.

1. A sterilization water tank comprising a tank body where water is contained 20;
and a silver foam 30 which is formed in foam pattern having a plurality of holes and is contained in the tank body 20;
and wherein the water in the tank body 20 may be sterilized by the silver foam 30.

2. The sterilization water tank of claim 1, wherein the silver foam 30 is contained in a permeable housing 40.
